(19) United States
(12) Patent Application Publication
(10) Pub. No.: US 2007/0026358 A1
(43) Pub. Date: Feb. 1, 2007

(54) Two-phase invisible orthodontics

(76) Inventor: Charles J. Schultz, West Babylon, NY (US)

Correspondence Address: Douglas J. Hura Esquire;DENTSPLY International Inc., 570 West College Avenue, P.O. Box 872, York, PA, 17405-0872, US

(21) Appl. No.: 11/189,520

(22) Filed: Jul. 26, 2005

(51) Int. Cl. A61C 3/00

(52) U.S. Cl. 433/24

(57) ABSTRACT

The present invention provides a two-phase orthodontic treatment for dental malocclusions that includes a first phase using traditional molar orthodontic appliances. The second phase employs a series of plastic aligner trays.

### TECHNICAL FIELD

The present invention is related to an improved method to correct orthodontic malocclusions. It includes a first phase employing traditional molar orthodontic appliances such as bands, wires and the like. A second phase employs a plastic tray which exerts orthodontic correcting forces to treat the malocclusion.

### BACKGROUND OF THE INVENTION

Orthodontics relates to creating space and moving the teeth within that space traditionally with appliances, wires, and some form of ligation. The lay word used is braces. This is a highly labor intensive system requiring frequent reactivations by the orthodontist to adjust the wires. These braces are mounted to the teeth using an adhesive/acid system that is uncomfortable for some adult patients and time consuming for the practitioner. It is also expensive.

Align Technology introduced treating patients, mainly adults, with a computer designed series of plastic trays. These trays take the original impression of the patient's teeth and use a digital database to create an actual mold of the teeth and then advance that mold's information to create a series of trays that attempt to treat the patient's malocclusion without braces. This has proven very expensive and time consuming, as it requires the long lead times to start treatment and it takes the plastic trays a long period of time to affect tooth movement. Busy adults have to be patient and carefully follow the regimen and the orthodontist/manufacturer many times has to recreate the series of trays as they need a mid-course correction due to either non-compliance or errors in the computer assumptions. Align, the original inventor of digital aligners, actually patented mid-course corrections and insurance when treatment is started. While the patient has virtually invisible treatment, it may take years to complete and generally involves a big compromise when compared to traditional treatment.

It is estimated that there are millions of patients that want their anterior teeth corrected, refuse braces, and can't afford the above system. Some of them turn to dental laminates to cosmetically cover the problem but these also are expensive and need to be replaced periodically. It is then important that a system be designed that is less costly as the InvisAlign System, does not entail fixing visible braces to the teeth, but that can correct the visible teeth that may be misaligned using a nearly invisible plastic tray system to satisfy the needs of the above patients. InvisAlign is also very restricted on the types of patients that can be treated using their designs.

Tooth positioners made of clear plastic were developed over 50 years ago to guide teeth near their treatment goal after fixed therapy. Digital imaging in orthodontics was presented early in, for example, U.S. Pat. No. 5,605,459. Ormco describes manipulating digital images of teeth for creating braces in U.S. Pat. No. 5,533,895 and other previous patents.

Laser scanning to produce a 3-D model of the teeth in U.S. Pat. Nos. 5,338,198 and 5,452,219. Digital manipulation is described in U.S. Pat. Nos. 5,607,305 and 5,587,912.

In phase one, an appliance such as the Pendex as shown in FIG. 1 can be used to expand the maxillary arch width while maintaining the anteriors with a clear passive tray. The expansion as shown above allows great space to be gained so that less enamel reduction and easier repositioning of the anterior teeth to the prescribed ideal finish may be more easily and predictably maintained.

The quad helix has been proven for decades to be useful to expand unnaturally narrow arches, especially younger females. After phase one with the quad helix, the digital model and the case will have most obstructions removed for path analysis and the quad helix is virtually impossible to see.

Palatal arch bars and their sheathes are very simple devices to rotation and distallize molars creating large amounts of space to allow the pre-molars to freely drift posteriorly while holding the anteriors in a passive clear tray during Phase I.

Lingual arches, used on the mandibular behind the teeth, are connected to the molar band and used to upright the anterior teeth while placing gentle pressure to promote dental alveolar lateral growth. Here no lower plastic tray is used until Phase II and again there will be greater space to use while making the digital prescriptive trays for Phase II.

### BRIEF SUMMARY OF THE INVENTION

There is provided according to the invention a two-phase method of orthodontically correcting maloccluded teeth that includes: A first phase aesthetic treatment regimen that begins with traditional molar orthodontic appliances and therapy to rotate, align, intrude and/or level the molar area. Path analysis via a CAD/CAM to see if stripping is needed and where it is best applied based on tooth width and arch width. A clear retaining tray is made to control the balance of teeth during Phase One. After the Phase I correction, taking a new impression with the molar correction and stripping in place and a bite registration and then digitally or realistically resetting the teeth to the ideal occlusion and creating a series of plastic trays that will complete the corrections from the Phase I position to the final ideal position when a retaining tray will be used to hold the position.

This invention concerns an improved method of aesthetically treating more patients using a two-phase treatment plan. It starts with an impression or digital scan of the patient's teeth and bite registration being sent digitally to a 3-D modeler such as OrthoCAD where a digital model of the teeth and their relationship are established. Millimeters of crowding are determined and the type of malocclusion analyzed to chart the following process. Bands or acrylic plates as indicated are applied to the posterior molars and mechanics used to derotate, intrude, torque, expand, and/or upright the molars, creating the space for at least one tooth's worth of space in each arch. This will allow better treatment with the plastic activators on the anteriors without fixed appliance therapy and anchorage for better retention after treatment.

### BRIEF DESCRIPTION OF THE DRAWINGS

FIG. 1 is a perspective view of one embodiment of a traditional molar orthodontic appliance useful in the practice of the present invention.

FIG. 2 is a perspective view of another embodiment of a traditional molar orthodontic appliance useful in the practice of the present invention.

FIG. 3 is a perspective view of another embodiment of a traditional molar orthodontic appliance useful in the practice of the present invention.

FIG. 4 is a perspective view of another embodiment of a traditional molar orthodontic appliance useful in the practice of the present invention.

FIG. 5 is a perspective view of a tray useful as a retainer or as one of a series of aligner trays used in the practice of the present invention.

### DETAILED DESCRIPTION OF THE INVENTION

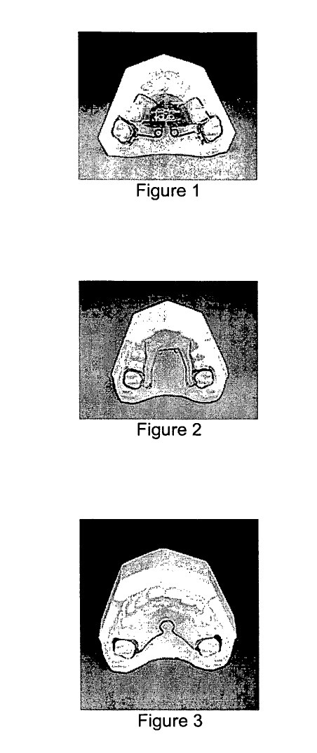

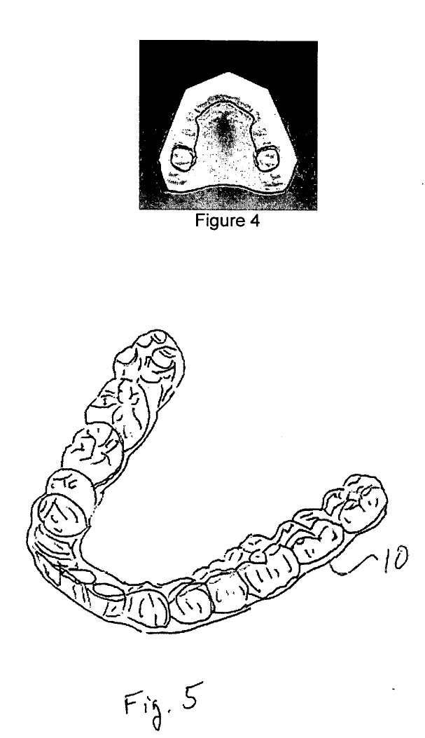

Since it is virtually impossible to see molars at the back of the mouth, more traditional appliances can be used to manipulate the molars gaining more space for the anterior teeth. Professionals may use lip bumpers, Crozats, palatal bars, Herbst, Distal Jets, expansion screws, Molar Movers, and other molar management appliances known to practitioners as are variously shown in FIGS. 1-4. This will generally recover, just through rotations and uprighting, the space for at least one anterior tooth in each arch. This will generate adequate space in the anteriors for correction and provide good anchorage for anterior movement. Further space, if needed, can be gained by judiciously stripping of teeth no more than 0.5 mm per side. The goal is to clear a path for the teeth to straighten without impediment. It is estimated that Phase I will last 2-6 months. Records will be kept of the individual tooth and arch width measurements before the stripping and after. Again, digital 3-D simulation can perform path analysis and the ideal amount of space needed and where it can be gained. Between stripping of anteriors and rotation of molars, it's possible that extraction of teeth on marginal cases can be avoided.

After setting up anchorage with the molars and stripping the teeth as needed, a new impression or digital scan and bite registration is sent to the digital computer aided design company and a treatment analysis is performed after the Phase I treatment of molar correction, anchorage and stripping.

A new scan or impression of the teeth now and analysis for the new, improved status of the anteriors. There has been much literature and clinical results of correcting the molar rotations and then holding them without any aesthetic affect. Cetlin, Gianelly, et al have written about these low compliance appliances with great affect. Computer analysis when it seems that maximum progress has been achieved with the molars and that any anterior-posterior correction has been achieved through the control of a removable plate on the anteriors, as dictated by Margolis and Cetlin during the last century. It has been described by others as “drift-odontics” as you open up space anterior to the molars and then wait for the middle teeth, or bicuspids, to drift to their final placement. This eliminates much discomfort of trying to mechanically correct the bicuspids, although the activator (active plastic tray) can be used for extreme cases. While the RPE, SPE, Pendulum, Burstone, et al appliances can replace the palatal arch bar system on the upper molars and a lip bumper on the lowers, it is intended that the inexpensive PAB/bumper system common to the profession be the preferred embodiment.

A final tray such as tray (10) in FIG. 5 is formed for all the teeth after the bands have been removed and placed to finalize correction and begin retention.

Generally, this process is to address the millions of adults that are at or near Class I or Class II Division I molar relationships and have crowded anteriors. Also, many patients that already completed orthodontic treatment in their youth and simply need to correct unattractive rotations could benefit from this system.

What is claimed is:

1. A two-phase method of orthodontically correcting malposed teeth comprising:
a. a first phase aesthetic treatment regimen that begins with traditional molar orthodontic appliances and therapy to rotate, align, intrude or level the molar area;
b. path analysis via a CAD/CAM to see if stripping is needed and where it is best applied based on tooth width and arch width;
c. a clear retaining tray is made to control the balance of teeth during Phase One;
d. after the Phase I correction, a new impression with the molar correction is made and stripping in place and a bite registration is performed if desired and then digitally or realistically resetting the teeth to the ideal occlusion and creating a series of plastic trays that will complete the corrections from the Phase I position to the final ideal position when a retaining tray will be used to hold the position.
